(19) United States
(12) Patent Application Publication
(10) Pub. No.: US 2015/0245744 A1
(43) Pub. Date: Sep. 3, 2015

(54) TEST TOOL ARRAY

(71) Applicant: Robinson Home Products Inc., Williamsville, NY (US)

(72) Inventors: Lou Henry, Scarsdale, NY (US); John Healy, Brooklyn, NY (US)

(73) Assignee: Robinson Home Products Inc., Williamsville, NY (US)

(21) Appl. No.: 14/193,729

(22) Filed: Feb. 28, 2014

(51) Int. Cl. A47J 43/28; A47G 21/02

(52) U.S. Cl. CPC A47J 43/288; A47G 21/02

(57) ABSTRACT

A test tool array having a plurality of test utensils each including a fixed end and a work end, the test utensils comprising a tasting spoon, a probe fork, a pasta hook, and a probe pin, wherein the test utensils are pivotally connected by one or more pivot connection members associated with the fixed ends of the test utensils.

### FIELD OF THE INVENTION

The present invention relates to a kitchen device for assisting with the preparation of food items, and specifically for testing the food items during the food preparation process.

### BACKGROUND OF THE INVENTION

It is well known that cooks, and particularly good cooks, test the food items that they are preparing during the preparation process. For example, it is common for a cook to use a spoon to taste test a sauce or soup that they are preparing. Similarly, a cook will use a fork to either remove a strand of pasta being boiled to determine whether it is fully cooked, to insert into a cake to ensure that the batter has been fully baked or to pierce a potato to see that it is not too hard and therefore not finished baking.

Of course, these common utensils may not be particularly well suited for the testing of these items during the cooking process. In this regard, a fork may be used to remove a strand of pasta from a boiling pot, but unless the strand is picked up near the middle it tends to slide off of the tines of the fork making capture difficult. Similarly, using a fork to test a cake requires that the tines be inserted a significant depth into the cake, potentially causing damage to the cake. Moreover, the fork tines may not be sufficiently long to test whether the batter in the middle of the cake is fully baked.

Additionally, the testing implements can quickly pile up if the cook cannot tell which fork was used for which test, requiring a new fork each time the test is taken. Also, more specialized tools for testing particular food items during the food preparation process take up valuable drawer space in a kitchen and may be difficult to find in a drawer crowed with different devices. Of course, the inability to find a needed device while cooking causes unnecessary frustration for any cook.

It would therefore be helpful to have dedicated test tools which are specially designed to meet particular needs in one place so that they are easy to find and familiar to use in particular cooking situations.

### SUMMARY OF THE INVENTION

To overcome these deficiencies, the present invention is directed to a test tool array having a plurality of test utensils each including a fixed end and a work end, the test utensils comprising a tasting spoon, a probe fork, a pasta hook, and a probe pin, wherein the each of the test utensils are pivotally connected by one or more pivot connection members associated with the fixed ends of the test utensils.

The test tool array of the present invention may have additional test or cooking utensils, as would be desired by a cook, which can be attached to the array either by addition to the pivot connection member or otherwise.

In the preferred embodiment, the tasting spoon is formed as a shallow ladle so that the food item being removed can cool quickly. Additionally, the tasting spoon can further include a plurality of protrusions within the concave spoon head, which allow for a liquid spooned from a cooking vessel to cool more quickly for tasting.

The preferred probe fork may have any desirable features, but would include two or more tines with sufficiently sharp points to allow a cook to puncture the skin of a potato, not only to test whether the potato center is still hard during cooking but also to create air escape holes in the potato skin prior to cooking, thereby preventing the buildup of gasses underneath the skin that may rupture the skin in an explosive manner during cooking.

It is also preferred that the pasta hook include a notched tip, where the notch tapers from a wide opening to a more narrow opening in a “V” shape. This configuration assists in catching a strand of pasta, and particularly capturing strands of pasta of differing widths, from linguini angel hair. The V shape permits the strand to move down to the proper depth to frictionally capture the strand so that the strand can be removed even if only secured by an end of the strand rather than the middle.

The preferred probe pin is a long thin member with a pointed end, such that it could reach the middle of a cake being baked without damaging the cake. Due to its preferred thin dimension, permitting probing without unduly damaging the food item, the probe pin must have sufficient structural rigidity to permit regular use without being deformed by bending or the like.

The test utensils preferably swivel or pivot independently on the pivot connection member so that each test utensil may be moved into a use configuration, away from the other test utensils, or into a storage configuration, in a common line with the other test utensils. The test tool array is preferably designed so that each test utensil may be individually pivoted into its use configuration without interference from any other test utensil and so that the test utensils may be pivoted into a storage configuration where the test utensils overlap each to take a minimum volume of space when stored.

The several test utensils and attachment member may be formed of any suitable material, including plastics, metals, elastomeric materials or any combination of these. However, in the most preferred embodiment, the test utensils are preferably manufactured of heat resistant materials, with the probe pin most preferably formed of a food grade stainless steel.

Moreover, the pivot connection member(s) may take any suitable form, including a single axel or pin that extends through cooperating openings at the fixed ends of the test utensils, or extensions off of each of the test utensils that engage the next utensil, in cascading fashion, with a cap over each end.

The test tool array may additionally have catch members or stop members to maintain one or more of the test utensils in the stored configuration. The catch members may be associated with the pivot connection member, the test utensils or combinations thereof. Alternatively, the test utensils may be held in the stored configuration, the use configuration or any intermediate configurations by a friction fit between the test utensils, the pivot connection member or a combination thereof.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a top plan view of a preferred embodiment of the test tool array of the present invention in a fanned out configuration, which displays each test utensil individually while attached to each other.

FIG. 2 is a perspective view of the preferred embodiment of the test tool array in a closed configuration, which allows for the device to take up the smallest amount of space.

FIG. 3 is an exploded view of the preferred embodiment of the present invention, showing the various test utensils having cooperating pivot connection members.

FIG. 4 is a partial perspective view of a tasting spoon with a plurality of cooling projections on the concave spoon surface.

### DETAILED DESCRIPTION OF THE PREFERRED EMBODIMENT

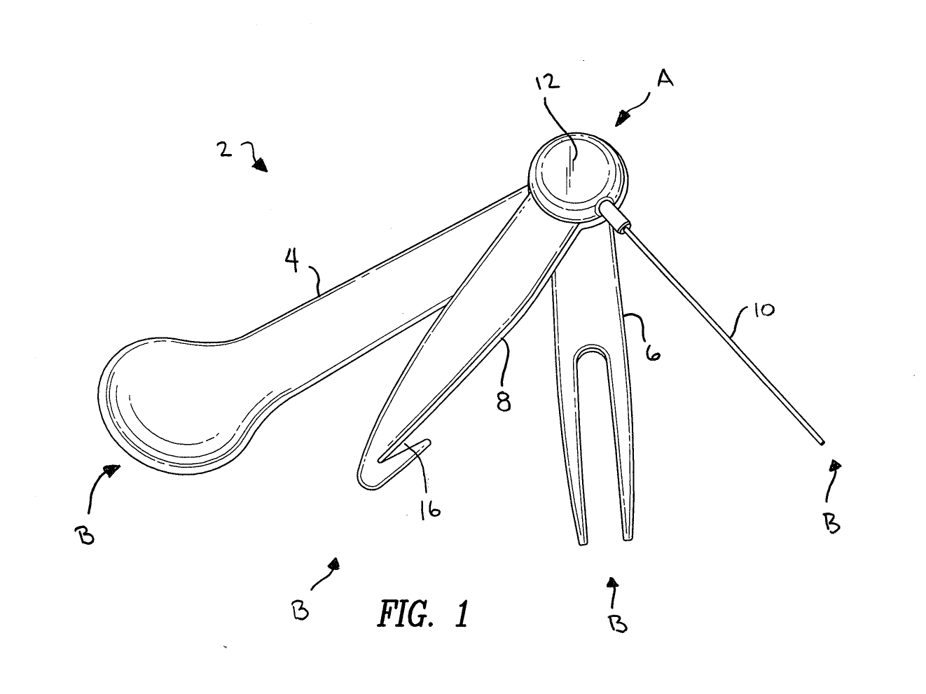

In the preferred embodiment shown in accompanying FIGS. 1 to 3, the test tool array 2 comprises a plurality of test utensils each including a fixed end A and a work end B, the test utensils comprising a tasting spoon 4, a probe fork 6, a pasta hook 8, and a probe pin 10, wherein the each of the test utensils are pivotally connected by one or more pivot connection members 12 associated with the fixed ends A of the test utensils.

As set out above, the tool utensils of the present invention may be formed of any suitable, heat resistant material. In this regard, the tasting spoon 4 and pasta hook 8 are particularly well suited for manufacture from a heat resistant plastic material. The probe fork is also well suited for manufacture from a heat resistant plastic material, but may require a plastic material with increased structural integrity since it may be used under more physically demanding circumstances. The probe pin may also be formed of a heat resistant plastic material, but is most preferably formed of a stainless steel to resist breaking and to provide a surface most user friendly to testing things like cake batter.

In the preferred embodiment shown, the tasting spoon 4 is the longest of the tool utensils, with the work end B formed as a shallow ladle so that the food item being removed can cool quickly. This provides that the spoon head on the work end B of the tasting spoon 4 will not create additional volume to the test tool array 2 in the closed configuration, where the area of the spoon head of the tasting spoon generally covers the working end B of the remaining tool utensils.

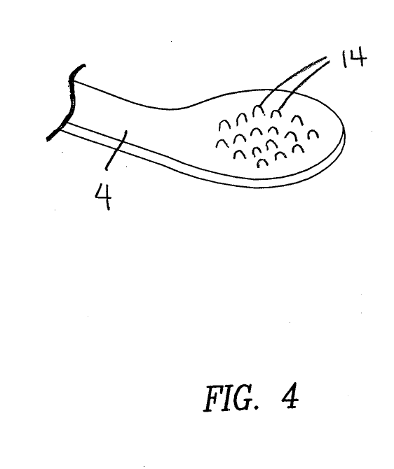

As shown in FIG. 4, an alternative embodiment of the tasting spoon 4 can further include a plurality of protrusions 14 within the concave spoon head on the work end B. The surface area of the protrusions 14 further act to allow for a liquid spooned from a cooking vessel to cool more quickly for tasting.

The preferred embodiment next includes a probe fork 6 having two or more tines having pointed ends at the work end B to puncture and/or probe a food items being cooked. To assist in moving the probe fork 6 into and out of the closed configuration, the probe fork 6 is substantially flat. Moreover, the tines of the probe fork 6 are preferably long and thin, however, any shape that can puncture and probe a food item may be used.

The preferred pasta hook 8 shown in the attached FIGS. 1 to 3 for use with the test tool array 2 is generally flat with a hook 16 at the work end B to capture strands of pasta and remove them from a pot of boiling water to check the firmness. Most preferably, the hook 16 comprises a “V” shaped opening with a wider mouth that reduces down to narrow bottom, so as to provide that a strand of pasta will slip down into the hook 16 to be frictionally caught by the walls of the hook 16. The depth that the strand catches in the hook 16 will depend on the thickness of the strand of pasta, with thicker pasta such as linguini catching higher in the hook 16 than angel hair.

In the preferred embodiment, the probe pin 10 is at the top of the test tool array 2. The sharp work end B is intended to carefully probe a food item without causing damage to the food item. Although the majority of test utensils are preferably formed of a rigid plastic, such as an acrylonitrile butadiene styrene (ABS) plastic, the probe pin is preferably formed of a stainless steel rod having a diameter of from about 1/64 to about ⅛ of an inch, and preferably about 1/16 of an inch. The probe pin 10 preferably terminates in a plastic receiver that comprises the fixed end A of the probe pin 10.

Although any device capable of holding the test utensils in a pivotable relationship may be used with the present invention, the preferred pivotal connection member 12 is one that holds the fixed ends A of the individual test utensils adjacent one another. Such a pivotal connection member 12 generally comprises an axel that passes through circular openings at the terminal fixed end A of at least the internal test utensils, with the end test utensils preferably comprising or retaining a cap that holds the test utensils together.

The pivot connection member 12 is shown in the attached Figures with cooperating axel elements on the fixed end A of the tasting spoon 4 and the probe pin 10 which interlock to hold the remaining test utensils therebetween. Also shown is a secondary cap 20 to cover the fixed end A on the bottom of the pivot connection member 12. These components and the terminal fixed ends A combine to create a preferred generally spherical shape.

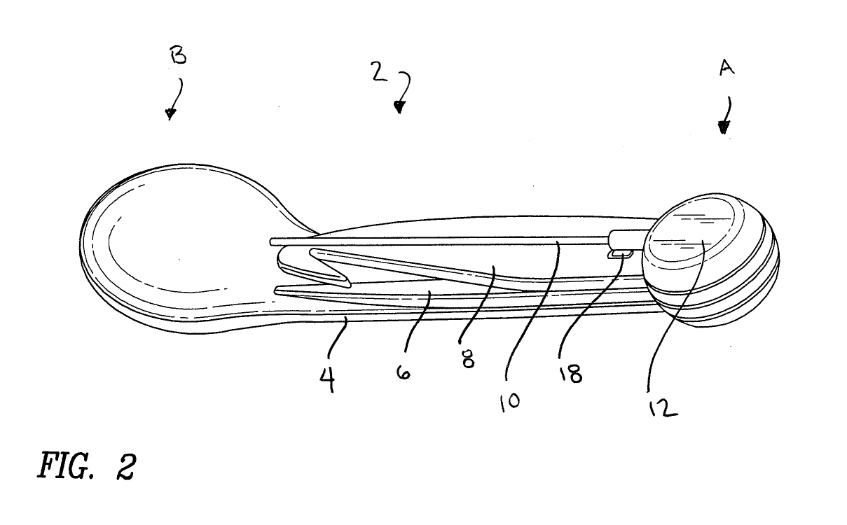

The frictional contact between the fixed ends A of adjacent test utensils is preferably sufficient to hold the test utensils in the positions that the user sets. For example, the frictional contact between adjacent fixed ends A will keep all of the test utensils in the closed configuration of FIG. 2, in the fanned array of FIG. 1 or with one test utensil extending in a different direction than the remaining test utensils for use.

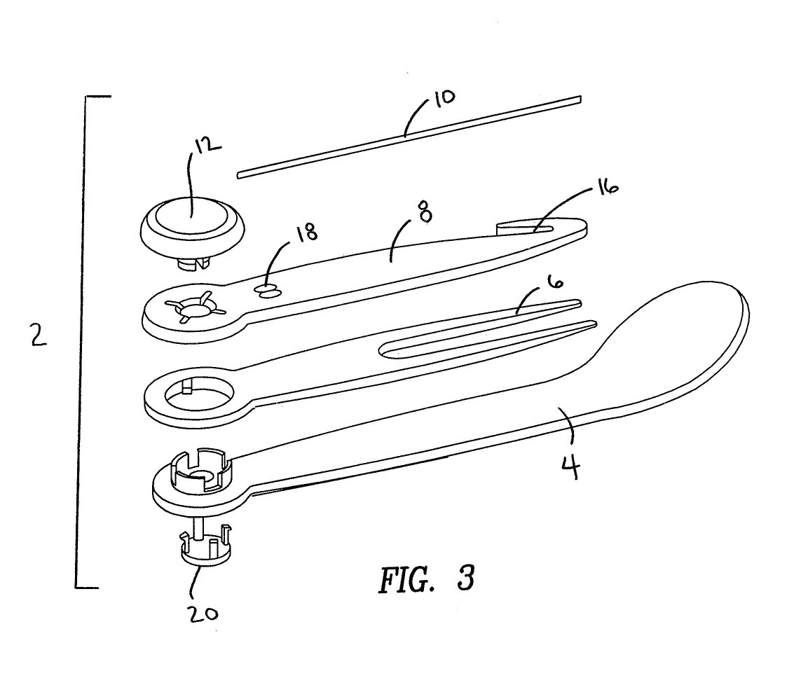

Of course, additional structural elements can be used to hold one or more of the test utensils in the closed configuration. For example, a catch element 18 may be used between adjacent test utensils, as shown on side of the pasta hook 8 in FIGS. 2 and 3 to retain the probe pin 10 in the closed configuration to avoid unwanted opening thereof and possible injury from the sharp work end B of the probe pin 10.

Variations, modifications and alterations to the above detailed description will be apparent to those skilled in the art. All such variations, modifications and/or alternatives are intended to fall within the scope of the present invention, limited only by the claims.

We claim:

1. A test tool array having a plurality of test utensils each including a fixed end and a work end, the test utensils comprising a tasting spoon, a probe fork, a pasta hook, and a probe pin, wherein the test utensils are pivotally connected by one or more pivot connection members associated with the fixed ends of the test utensils.

2. The test tool array of claim 1 further comprising one or more test utensils taken from the group consisting of a thermometer, a knife, a peeler and combinations thereof.

3. The test tool array of claim 1 wherein a concave surface of the tasting spoon comprises a plurality of cooling protrusions.

4. The test tool array of claim 3 wherein the tasting spoon is formed of a rigid or semi-rigid material.

5. The test tool array of claim 1 wherein the probe fork comprises at least two tines.

6. The test tool array of claim 5 wherein the probe fork is formed of a rigid material.

7. The test tool array of claim 1 wherein the work end of the pasta hook comprises a V-shaped opening where the mouth of the opening is wider than the bottom of the opening.

8. The test tool array of claim 7 wherein the pasta hook is formed of a rigid or semi-rigid material.

9. The test tool array of claim 1 wherein the probe pin is formed of a stainless steel rod with a pointed work end.

10. The test tool array of claim 1 wherein the pivotal connection member comprises an axel that extends through a hole in the fixed end of one or more test utensils.

11. The test tool array of claim 10 wherein the axel comprises cooperating axel members associated with exterior test tools that fit together in a locked relationship.

12. The test tool array of claim 1 further comprising a catch element on one or more of the test utensils for holding an adjacent test utensil in its closed relationship.

13. The test tool array of claim 1 wherein one or more of the test utensils are formed of a heat resistant material.
